(19) United States
(12) Patent Application Publication
(10) Pub. No.: US 2015/0153751 A1
(43) Pub. Date: Jun. 4, 2015

(54) POWER SUPPLY CIRCUIT AND ELECTRONIC CONTROL UNIT EMPLOYING THE SAME

(71) Applicants: Eiichiro Shigehara, Nagoya-shi (JP); Keisuke Hata, Miyoshi-shi (JP); Junichi Fukuta, Kuwana-shi (JP); Tomohisa Ose, Nukata-gun (JP); Yusuke Shindo, Nagoya-shi (JP)

(72) Inventors: Eiichiro Shigehara, Nagoya-shi (JP); Keisuke Hata, Miyoshi-shi (JP); Junichi Fukuta, Kuwana-shi (JP); Tomohisa Ose, Nukata-gun (JP); Yusuke Shindo, Nagoya-shi (JP)

(73) Assignees: DENSO CORPORATION, Kariya-shi, Aichi-ken (JP); TOYOTA JIDOSHA KABUSHIKI KAISHA, Toyota-shi, Aichi-ken (JP)

(21) Appl. No.: 14/382,022

(22) PCT Filed: Mar. 5, 2013
(86) PCT No.: PCT/IB2013/000509

§ 371 Date: Aug. 29, 2014

(30) Foreign Application Priority Data
Mar. 8, 2012 (JP) 2012-051646

(51) Int. Cl. G05F 1/575

(52) U.S. Cl. CPC G05F 1/575

(57) ABSTRACT

A power supply circuit converts an input electric power into a target voltage and outputs the target voltage is equipped with a power semiconductor element that is connected between an input and an output, a drive circuit that adjusts operation of the power semiconductor element on the basis of a result of a comparison between an output voltage of the power supply circuit and a threshold voltage based on a first reference voltage, and a first monitoring circuit that compares the output voltage with a normal range based on a second reference voltage and outputs a first signal when the output voltage is deviant from the normal range. In addition, the first reference voltage and the second reference voltage are generated in different reference voltage generation circuits.

### BACKGROUND OF THE INVENTION

1. Field of the Invention

The invention relates to a power supply circuit and an electronic control unit employing the power supply circuit. In particular, the invention relates to a power supply circuit such as a series power supply circuit or a switching power supply circuit.

2. Description of Related Art

There is known a power supply circuit that is equipped with a power semiconductor element that is interposed between an input and an output, and a drive circuit that monitors output voltage or both output voltage and output current, and adjusts the operation of the power semiconductor element so that the output voltage becomes predetermined value. The drive circuit adjusts the operation of the power semiconductor element on the basis of a result of a comparison between an output voltage of the power supply circuit and a threshold voltage. Thus, the power supply circuit converts an input electric power into a target voltage, and outputs the target voltage. In Japanese Patent Application Publication No. 2009-303384 (JP-2009-303384 A), there is described an example of a switching power supply circuit.

The output voltage of the power supply circuit is supplied, as a power supply voltage, to an arithmetic processing circuit, for example, a microprocessor. It should be noted herein that when the output voltage of the power supply circuit deviates from a normal range, the arithmetic processing circuit is not supplied with a correct power supply voltage, and a malfunction in the arithmetic processing circuit is incurred. Thus, there are also some conventional power supply circuits that are equipped with a monitoring circuit that compares an output voltage of a power supply circuit with a predetermined threshold voltage to detect an abnormality in the output voltage.

However, in each of the conventional power supply circuits, a threshold voltage used in a drive circuit and a threshold voltage used in a monitoring circuit are generated from a common reference voltage generation circuit. In this configuration, in the case where an inconvenience is caused in, for example, the reference voltage generation circuit, the threshold voltage in the drive circuit and the threshold voltage in the monitoring circuit fluctuate in the same manner. Accordingly, even if the output voltage of the power supply circuit is in an abnormal range, the monitoring circuit cannot detect the abnormality. The abnormality in the power supply circuit is overlooked, and a malfunction in the arithmetic processing circuit is incurred.

### SUMMARY OF THE INVENTION

The invention provides a power supply circuit capable of more correctly detecting an abnormality in an output voltage, and an electronic control unit employing this power supply circuit.

A power supply circuit according to a first aspect of the invention, which converts an input electric power into a target voltage and outputs the target voltage, includes a power semiconductor element that is connected between an input and an output of the power supply circuit, a drive circuit that adjusts operation of the power semiconductor element on the basis of a result of a comparison between an output voltage of the power supply circuit and a first threshold voltage based on a first reference voltage, and a first monitoring circuit that compares the output voltage with a first normal range based on a second reference voltage and outputs a first signal when the output voltage is deviant from the first normal range. In this power supply circuit, the first reference voltage and the second reference voltage are generated in different reference voltage generation circuits.

According to the foregoing aspect of the invention, an abnormality in the output voltage of the power supply circuit can be correctly detected.

In the foregoing aspect of the invention, the power supply circuit may include a second monitoring circuit that compares the output voltage with a second normal range based on the first reference voltage, and outputs a second signal when the output voltage is deviant from the second normal range.

According to the foregoing aspect of the invention, the two monitoring circuits can monitor the output voltage of the power supply circuit in a complementary manner. In particular, the second monitoring circuit uses the threshold voltage generated from the first reference voltage, as is the case with the drive circuit. For this reason, an inconvenience in the power semiconductor element or the like can be directly detected, ignoring voltage fluctuations occurring in the first reference voltage.

In the foregoing aspect of the invention, the first normal range, which is determined in the first monitoring circuit, may be narrower than the second normal range, which is determined in the second monitoring circuit.

In the foregoing aspect of the invention, the power supply circuit may further be equipped with a first reference voltage generation circuit that generates the first reference voltage, and a second reference voltage generation circuit that generates the second reference voltage.

An electronic control unit according to a second aspect of the invention includes a first power supply circuit, a first arithmetic processing circuit that operates using the first power supply circuit as a power supply thereof, a second power supply circuit, a second arithmetic processing circuit that operates using the second power supply circuit as a power supply thereof, and a sensor that measures at least one physical quantity and outputs a measurement result thereof to the first arithmetic processing circuit and the second arithmetic processing circuit. In this electronic control unit, at least one of the first power supply circuit and the second power supply circuit is the power supply circuit according to the first aspect of the invention, a first signal that is output by at least one of the first power supply circuit and the second power supply circuit is input to at least one of the first arithmetic processing circuit and the second arithmetic processing circuit, the first arithmetic processing circuit or the second arithmetic processing circuit that has received the first signal communicates with the other arithmetic processing circuit, and at least one of the first arithmetic processing circuit and the second arithmetic processing circuit compares measurement results of the sensor, which are grasped by the respective arithmetic processing circuits, with each other to determine whether or not the first power supply circuit or the second power supply circuit is abnormal.

An electronic control unit according to a third aspect of the invention includes a first arithmetic processing circuit, a first power supply circuit that supplies an electric power to the first arithmetic processing circuit, a second arithmetic processing circuit that communicates with the first arithmetic processing circuit, a second power supply circuit that supplies an electric power and a first signal to the second arithmetic processing circuit, and a sensor that measures at least one physical quantity and transmits a measurement result of the physical quantity to the first arithmetic processing circuit and the second arithmetic processing circuit. In this electronic control unit, at least one of the first power supply circuit and the second power supply circuit is the power supply circuit according to the first aspect of the invention, the second arithmetic processing circuit communicates information on the measurement result to the first arithmetic processing circuit upon receiving the first signal, and at least one of the first arithmetic processing circuit and the second arithmetic processing circuit makes a comparison on the measurement result to determine whether or not the first power supply circuit or the second power supply circuit is abnormal.

According to the foregoing second or third aspect of the invention, the reliability in detecting an abnormality in the output voltage can be enhanced.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a circuit block diagram showing an electronic control circuit according to the first embodiment of the invention;

FIG. 2 is a graph showing a criterion on an output voltage of a power supply circuit;

FIG. 3 is a circuit block diagram showing an electronic control circuit according to the second embodiment of the invention; and

FIG. 4 is a circuit block diagram showing an electronic control circuit according to the third embodiment of the invention.

### DETAILED DESCRIPTION OF EMBODIMENTS

The invention can be favorably adopted in both a series power supply circuit and a switching power supply circuit. In the case of a series power supply circuit, a drive circuit with voltage regulator of a power semiconductor element (a bipolar transistor or a field-effect transistor) adjusts the base current or gate voltage of the power semiconductor element on the basis of a result of a comparison between an output voltage of the power supply circuit and a threshold voltage. Thus, the output voltage of the power supply circuit can be held equal to a target voltage by adjusting the operation of the power semiconductor element (the width of voltage drop in the power semiconductor element), which functions as a variable resistance. On the other hand, in the case of a switching power supply circuit, a drive circuit can hold the output voltage of the power supply circuit equal to a target voltage by adjusting the operation of the power semiconductor element (a duty ratio), which functions as a switching element, on the basis of a result of a comparison between the output voltage of the power supply circuit and a threshold voltage. Also, the drive circuits of both the series power supply circuit and the switching power supply circuit may monitor output current in addition to monitor output voltage.

In one embodiment of the invention, each of a first normal range and a second normal range may be a range defined only by a lower-limit or an upper-limit (e.g., equal to or higher than X Volt(s) or equal to or lower than X Volt(s)), or a range defined by an upper-limit and a lower-limit (e.g., equal to or higher than Y Volt(s) and equal to or lower than Z Volt(s)).

In one embodiment of the invention, the power supply circuit may be a step-down power supply circuit or a step-up power supply circuit. The invention can be widely adopted in a power supply circuit that performs feedback control of the output voltage.

In one embodiment of the invention, a first signal and a second signal that are output by a first monitoring circuit and a second monitoring circuit respectively may be any signals. These signals may be optical signals, magnetic signals, or acoustic signals as well as high-level electric signals, low-level electric signals, floating electric signals or other electric signals.

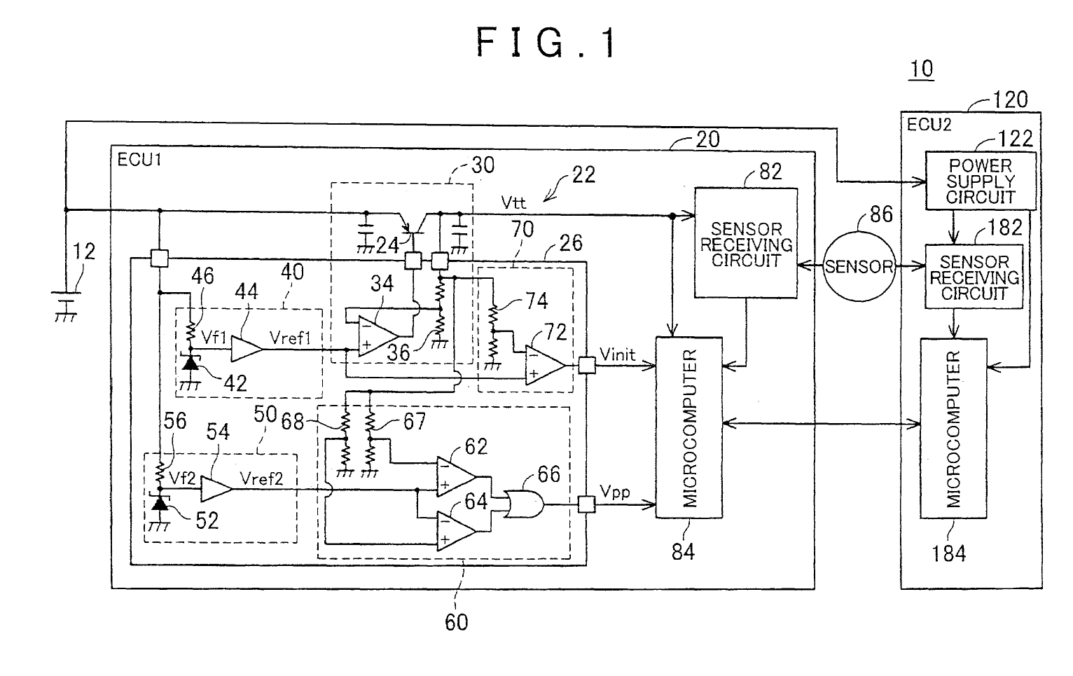

An electronic controller 10 according to the first embodiment of the invention will be described with reference to FIG. 1. The electronic controller 10 according to the first embodiment of the invention is mounted on, for example, an automobile, and controls various devices of the automobile.

As shown in FIG. 1, the electronic controller 10 is equipped with a plurality of electronic control units including a first electronic control unit 20 and a second electronic control unit 120. The respective electronic control units 20 and 120 control the operations of, for example, a power unit (an engine), a brake unit, a power steering unit and the like of the automobile, although these units are not shown in the drawing. The electronic controller 10 is equipped with a sensor 86 for measuring a physical quantity regarding a control target. An output signal of the sensor 86 is input to the respective electronic control units 20 and 120.

The first electronic control unit 20 is mainly equipped with a power supply circuit 22, a sensor receiving circuit 82, and an arithmetic processing circuit (a microcomputer) 84. The sensor receiving circuit 82 and the arithmetic processing circuit 84 are supplied with an electric power from a direct-current power supply 12 of the automobile through the power supply circuit 22. The power supply circuit 22 converts the electric power input thereto from the direct-current power supply 12 of the automobile, into a target voltage suited for the sensor receiving circuit 82 and the arithmetic processing circuit 84. The power supply circuit 22 according to this embodiment of the invention is a so-called series power supply circuit, but may be a switching power supply circuit. Besides, the power supply circuit 22 is not absolutely required to be a step-down power supply circuit, but may be a step-up power supply circuit. In this embodiment of the invention, the output voltage of the direct-current power supply 12 is about 8 to 12 V, and the target voltage output by the power supply circuit 22 is 5 V, although these values are examples.

The second electronic control unit 120 is similar in configuration to the first electronic control unit 20. That is, the second electronic control unit 120 is also equipped with a power supply circuit 122, a sensor receiving circuit 182, and an arithmetic processing circuit (a microcomputer) 184. Since the two electronic control units 20 and 120 are substantially identical in configuration, the configuration of the first electronic control unit 20 will be described hereinafter in detail, while the description of the second electronic control unit 120 will be omitted. Incidentally, since the control targets of the first electronic control unit 20 and the second electronic control unit 120 are different from each other, the processes executed by the respective arithmetic processing circuits 84 and 184 (i.e., the data and programs stored therein) are different from each other.

The power supply circuit 22 is equipped with a bipolar transistor 24, and a power supply control circuit 26 that controls the operation of the bipolar transistor 24. The power supply control circuit 26 is equipped with a drive circuit 34 that is connected to a base of the bipolar transistor 24, a first reference voltage generation circuit 40 that generates a first reference voltage (Vref1), a second reference voltage generation circuit 50 that generates a second reference voltage (Vref2), a first monitoring circuit 60 that monitors an output voltage (Vtt) of the power supply circuit 22, and a second monitoring circuit 70 that monitors the output voltage (Vtt) of the power supply circuit 22. Incidentally, the bipolar transistor 24 may be a power semiconductor element such as a field-effect transistor or the like.

The drive circuit 34 is mainly constituted of a comparator. The drive circuit 34 compares an output voltage of the power supply circuit 22 with a threshold voltage based on the first reference voltage, and applies a voltage corresponding to a relationship in magnitude between both the voltages to the base of the bipolar transistor 24. That is, the drive circuit 34 adjusts the base current of the bipolar transistor 24 in accordance with the relationship in magnitude between the output voltage and the threshold voltage. As a result, the width of voltage drop occurring in the bipolar transistor 24 changes, and the bipolar transistor 24 functions as a kind of variable resistor. In this manner, the drive circuit 34 adjusts the operation of the bipolar transistor 24, whereby the output voltage of the power supply circuit 22 is stably held equal to a target voltage. The drive circuit 34 according to this embodiment of the invention directly uses the first reference voltage as the threshold voltage, but can also adjust the first reference voltage with the aid of a voltage divider circuit or the like and use the adjusted voltage as the threshold voltage. As described above, in the power supply circuit 22 according to this embodiment of the invention, a step-down converter (more specifically, a series regulator) 30 is constituted using the bipolar transistor 24, the drive circuit 34, and a voltage divider circuit 36.

The first reference voltage generation circuit 40 is equipped with a zener diode 42 and an amplification circuit 44. The zener diode 42 is connected in such a manner as to be reversely biased with respect to the direct-current power supply 12, and generates a constant voltage (Vf1) through a zener effect. The constant voltage generated by the zener diode 42 is amplified by the amplification circuit 44, and is output as the first reference voltage (Vref1). A relatively high-resistance resistor element 46 is connected in series to the zener diode 42, so as to suppress the electric power loss resulting from the zener diode 42.

The second reference voltage generation circuit 50 is similar in configuration to the first reference voltage generation circuit 40. That is, the second reference voltage generation circuit 50 is also equipped with a zener diode 52 and an amplification circuit 54. A relatively high-resistance resistor element 56 is connected in series to the zener diode 52. As is the case with the first reference voltage generation circuit 40, the second reference voltage generation circuit 50 amplifies a constant voltage (Vf2) generated by the zener diode 52 in the amplification circuit 54, thereby generating the second reference voltage (Vref2).

The first reference voltage generation circuit 40 and the second reference voltage generation circuit 50 are provided in parallel with the direct-current power supply 12. Accordingly, even if an inconvenience is caused in one of the reference voltage generation circuits 40 and 50, the other reference voltage generation circuit 50 or 40 is not affected by the inconvenience. Incidentally, in this embodiment of the invention, the first reference voltage generation circuit 40 and the second reference voltage generation circuit 50 are built in the same first electronic control unit 20. However, these two reference voltage generation circuits 40 and 50 may be provided in the separate electronic control units 20 and 120 respectively. Besides, as long as the first reference voltage generation circuit 40 and the second reference voltage generation circuit 50 are structured independently of each other such that an inconvenience in one of them does not affect the other, no problem is caused. The first reference voltage generation circuit 40 and the second reference voltage generation circuit 50 are not required to employ the same direct-current power supply 12, but may utilize power supplies that are different from each other.

The first monitoring circuit 60 compares an output voltage of the power supply circuit 22 with a threshold voltage based on the second reference voltage. Then, when the output voltage is deviant from a first normal range, the first monitoring circuit 60 outputs an alarm signal (Vpp) as a first signal. The first monitoring circuit 60 according to this embodiment of the invention is a window comparator, although it is an example. The first monitoring circuit 60 is equipped with two comparators 62 and 64, and an OR circuit 66 that outputs a logical sum of outputs of those comparators. The second reference voltage is input as a threshold voltage to each of the comparators 62 and 64. Besides, an output voltage of the power supply circuit 22 is input to each of the comparators 62 and 64 via a corresponding one of separate voltage divider circuits 67 and 68 whose division ratios are different from each other. In the comparator 62, the second reference voltage is input to a non-inverting input terminal, and the (divided) output voltage of the power supply circuit 22 is input to an inverting input terminal, so that a high-level signal is output when the output voltage of the power supply circuit 22 is lower than a lower-limit of the first normal range. Besides, in the comparator 64, the second reference voltage is input to an inverting input terminal, and the (divided) output voltage of the power supply circuit 22 is input to a non-inverting input terminal, so that a high-level signal is output when the output voltage of the power supply circuit 22 is higher than an upper-limit of the first normal range. Those output signals are input to an OR circuit 66. As a result, when the output voltage of the power supply circuit 22 is deviant from the first normal range, the alarm signal (Vpp) is output from the OR circuit 66. It should be noted herein that the alarm signal (the first signal) may be any signal, for example, a high-level signal, a low-level signal, a floating signal, or another signal.

As described above, the threshold voltage used in the drive circuit 34 and the threshold voltage used in the first monitoring circuit 60 are generated from the separate reference voltage generation circuits 40 and 50 respectively. According to this configuration, if an inconvenience is caused in one of the reference voltage generation circuits 40 and 50, the first signal indicating an abnormality is output from the first monitoring circuit 60. For example, if an inconvenience is caused in the first reference voltage generation circuit 40, the threshold voltage used in the drive circuit 34 is not correctly generated, and the output voltage of the power supply circuit 22 deviates from the normal range. However, the inconvenience caused in the first reference voltage generation circuit 40 does not affect the threshold voltage used in the first monitoring circuit 60. Accordingly, the first monitoring circuit 60 can correctly detect an abnormality in the output voltage of the power supply circuit 22. On the other hand, if an inconvenience is caused in the second reference voltage generation circuit 50, the threshold used in the first monitoring circuit 60 is not correctly generated. As a result, even if there is no abnormality in the output voltage of the power supply circuit 22, the first monitoring circuit 60 determines that the output voltage of the power supply circuit 22 is abnormal, and outputs the first signal. As a result, the output voltage of the power supply circuit 22 can be prevented in advance from deviating from the normal range.

The second monitoring circuit 70 compares the output voltage of the power supply circuit 22 with a threshold voltage based on the first reference voltage. Then, when the output voltage is deviant from a second normal range, the second monitoring circuit 70 outputs a reset signal (Vinit) as a second signal. The second monitoring circuit 70 is equipped with a comparator 72. The first reference voltage is input to the comparator 72 as the threshold voltage, and the output voltage of the power supply circuit 22 is input to the comparator 72 via a voltage divider circuit 74. When the output voltage of the power supply circuit 22 is lower than the second normal range, the comparator 72 outputs a reset signal. That is, the second normal range is a range that is defined only by a lower-limit. Thus, an inconvenience in the power semiconductor element or the like can be directly detected while ignoring voltage fluctuations occurring in the first reference voltage. Incidentally, the second normal range can also be made a voltage range with a certain width, by employing a window comparator as the second monitoring circuit 70. Besides, the reset signal (the second signal) may be any signal, for example, a high-level signal, a low-level signal, a floating signal, or another signal.

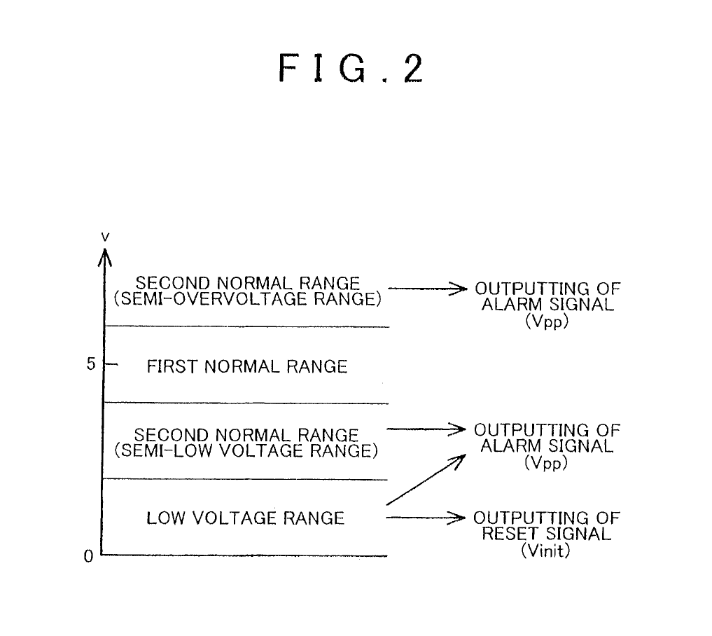

As shown in FIG. 2, the first normal range is set narrower than the second normal range. The first normal range is set as a range in which an arithmetic processing circuit 84 and the like are surely guaranteed to operate normally. On the other hand, the second normal range is set as a range in which the arithmetic processing circuit 84 and the like can be expected to operate normally but some problem such as an inconvenience in the first reference voltage generation circuit 40 or the step-down converter 30 or the like is assumed to arise. In the case where the output voltage of the power supply circuit 22 is deviant from the first normal range, an alarm signal is output from the first monitoring circuit 60 to the arithmetic processing circuit 84. Furthermore, when the output voltage of the power supply circuit 22 deviates from the second normal range as well, a reset signal is output from the second monitoring circuit 70 to the arithmetic processing circuit 84. In this manner, a two-stage determination is made on the output voltage of the power supply circuit 22. Thus, a measure can be taken in a two-stage manner in accordance with the degree of an abnormality. In the case where the output voltage of the power supply circuit 22 is deviant from the second normal range (i.e., in a low-voltage range), the arithmetic processing circuit 84 or the like may malfunction. For this reason, the arithmetic processing circuit 84 is programmed to execute a predetermined process to immediately stop the operation of a control target (a device of the automobile in this case) upon receiving the reset signal.

On the other hand, even when receiving an alarm signal from the first monitoring circuit 60, the arithmetic processing circuit 84 does not immediately determine that there is an abnormality. This is because the arithmetic processing circuit 84 can be expected to operate normally, and minor voltage fluctuations from a target voltage often result from a temporary factor at that moment. For this reason, the arithmetic processing circuit 84 of the first electronic control unit 20 is configured to communicate with an arithmetic processing circuit 184 of the second electronic control unit 120 upon receiving an alarm signal from the first monitoring circuit 60, so as to verify the plausibility of a detected abnormality.

Each of the arithmetic processing circuits 84 and 184 of the electronic control units 20 and 120 acquires an output signal of the sensor 86 through a corresponding one of the sensor receiving circuits 82 and 182, and grasps a physical quantity as a measurement object of the sensor 86 (e.g., a vehicle speed or the like of the automobile). If there is no abnormality in the output voltage of the power supply circuit 22, the physical quantities grasped by the respective arithmetic processing circuits 84 and 184 ought to substantially coincide with each other. In contrast, if the physical quantities grasped by the respective arithmetic processing circuits 84 and 184 are different from each other, it can be determined that there is an abnormality in the output voltage of the power supply circuit 22, and that there is a malfunction or the like in the arithmetic processing circuit 84. The arithmetic processing circuit 84 of the first electronic control unit 20, which has received the alarm signal, compares the self-grasped physical quantity with the physical quantity grasped by the arithmetic processing circuit 184 of the second electronic control unit 120, and determines that there is an abnormality in the output voltage of the power supply circuit 22 if both the physical quantities are substantially different from each other. At this moment, with a view to preventing the further occurrence of a malfunction, the arithmetic processing circuit 84 shifts to a fail-safe operation mode, for example, to limit the processes or functions to be executed. A verification result (normality/abnormality) obtained by the arithmetic processing circuit 84 of the first electronic control unit 20 is taught to the arithmetic processing circuit 184 of the other electronic control unit 120 as well.

As described above, when an abnormality is detected by the first monitoring circuit 60, the electronic controller 10 according to this embodiment of the invention compares the physical quantities that are grasped from the common sensor 86 between the two or more arithmetic processing circuits 84 and 184, thereby verifying the plausibility of abnormality detection. According to this configuration, even in the case where the first normal range in the first monitoring circuit 60 is set narrow to enhance the sensitivity of abnormality detection, eventual erroneous detection can be prevented, and the reliability of abnormality detection can be enhanced.

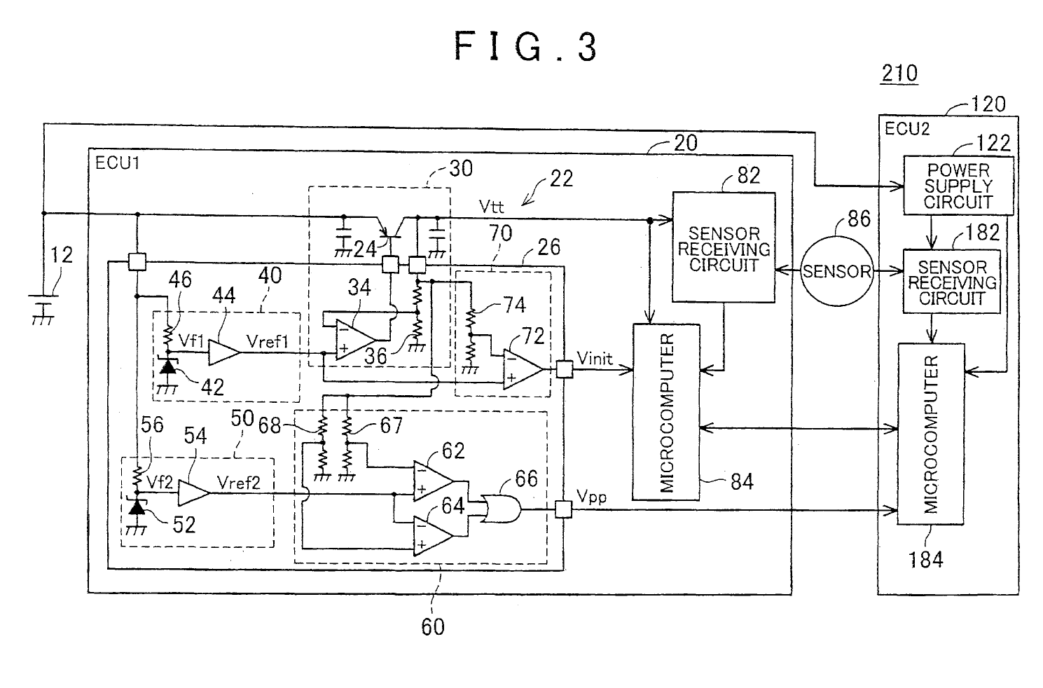

An electronic controller 210 according to the second embodiment of the invention will be described with reference to FIG. 3. The electronic controller 210 according to this embodiment of the invention is different from the electronic controller 10 according to the first embodiment of the invention in that the reset signal output by the first monitoring circuit 60 is input to the arithmetic processing circuit 184 of the second electronic control unit 120. Since both the embodiments of the invention are structurally identical to each other in other respects, the same reference symbols are assigned to the components thereof respectively to omit the redundant description herein.

In this embodiment of the invention, upon receiving an alarm signal from the first monitoring circuit 60, the arithmetic processing circuit 184 of the second electronic control unit 120 communicates with the arithmetic processing circuit 84 of the first electronic control unit 20, and verifies the plausibility of a detected abnormality. The arithmetic processing circuit 184 of the second electronic control unit 120 compares a self-grasped physical quantity with a physical quantity grasped by the arithmetic processing circuit 84 of the first electronic control unit 20, and determines that there is an abnormality in the output voltage of the power supply circuit 22 if both the physical quantities are substantially different from each other. A verification result obtained by the arithmetic processing circuit 184 of the second electronic control unit 120 is taught to the arithmetic processing circuit 84 of the first electronic control unit 20. At this moment, with a view to preventing the further occurrence of a malfunction, the arithmetic processing circuit 84 of the first electronic control unit 20 shifts to a failsafe operation mode, for example, to limit the processes or functions to be executed. Incidentally, the arithmetic processing circuit 84 of the first electronic control unit 20 may verify the plausibility of abnormality detection through a comparison between the physical quantities.

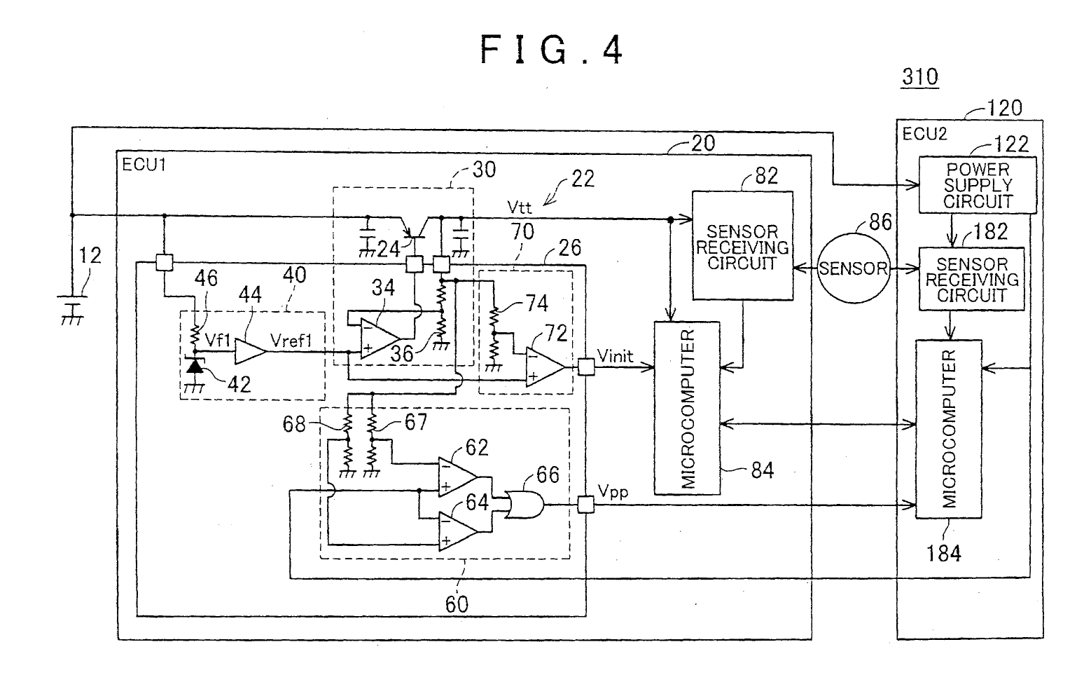

An electronic controller 310 according to the third embodiment of the invention will be described with reference to FIG. 4. The electronic controller 310 according to this embodiment of the invention is different from the electronic controller 210 according to the second embodiment of the invention in that the first monitoring circuit 60 uses, as a threshold voltage, a reference voltage generated in the power supply circuit 122 of the second electronic control unit 120. Since both the embodiments of the invention are identical to each other in other respects, the same reference symbols are assigned to the components thereof respectively to omit the redundant description herein. In this manner, the power supply circuit 22 of the first control unit 20 is not absolutely required to have the two or more reference voltage generation circuits 40 and 50 built therein, and may use, as the second reference voltage, a reference voltage that is generated by another circuit device or the like.

Although the concrete examples of the invention have been described in detail, they are nothing more than exemplifications, and are not intended to limit the claims. The art set forth in the claims includes various modifications and alterations of the concrete examples exemplified above.

The technical elements described in the present specification or the drawings exhibit their technical usefulness either alone or in various combinations, and are not limited to the combinations set forth in the claims at the time of the filing of the application. Besides, the art exemplified in the present specification or the drawings simultaneously achieves a plurality of objects, and is technically useful by achieving one of these objects alone.

1. A power supply circuit that converts an input electric power into a target voltage and outputs the target voltage, comprising:
a power semiconductor element that is connected between an input and an output of the power supply circuit;
a first reference voltage generation circuit that generates a first reference voltage;
a second reference voltage generation circuit different from the first reference voltage generation circuit that generates a second reference voltage;
a drive circuit that adjusts operation of the power semiconductor element on a basis of a result of a comparison between an output voltage of the power supply circuit and a first threshold voltage based on the first reference voltage; and
a first monitoring circuit that compares the output voltage with a first normal range based on a second reference voltage, and outputs a first signal when the output voltage is deviant from the first normal range, and
a second monitoring circuit that compares the output voltage with a second normal range based on the first reference voltage, and outputs a second signal when the output voltage is deviant from the second normal range.

2. The power supply circuit according to claim 1, wherein
the first normal range, which is determined in the first monitoring circuit, is narrower than the second normal range, which is determined in the second monitoring circuit.

3. An electronic control unit comprising:
a first power supply circuit;
a first arithmetic processing circuit that operates using the first power supply circuit as a power supply thereof;
a second power supply circuit;
a second arithmetic processing circuit that operates using the second power supply circuit as a power supply thereof; and
a sensor that measures at least one physical quantity, and outputs a measurement result thereof to the first arithmetic processing circuit and the second arithmetic processing circuit, wherein
at least one of the first power supply circuit and the second power supply circuit is the power supply circuit according to claim 1,
a first signal that is output by at least one of the first power supply circuit and the second power supply circuit is input to at least one of the first arithmetic processing circuit and the second arithmetic processing circuit,
the first arithmetic processing circuit or the second arithmetic processing circuit that has received the first signal communicates with the other arithmetic processing circuit, and
at least one of the first arithmetic processing circuit and the second arithmetic processing circuit compares measurement results of the sensor, which are grasped by the respective arithmetic processing circuits, with each other to determine whether or not the first power supply circuit or the second power supply circuit is abnormal.

4. An electronic control unit comprising:
a first arithmetic processing circuit;
a first power supply circuit that supplies an electric power to the first arithmetic processing circuit;
a second arithmetic processing circuit that communicates with the first arithmetic processing circuit;
a second power supply circuit that supplies an electric power to the second arithmetic processing circuit, and supplies a first signal to at least one of the first arithmetic processing circuit and the second arithmetic processing circuit; and
a sensor that measures at least one physical quantity, and transmits a measurement result of the physical quantity to the first arithmetic processing circuit and the second arithmetic processing circuit, wherein
the second power supply circuit is the power supply circuit according to claim 1,
the first arithmetic processing circuit or the second arithmetic processing circuit that has received the first signal communicates the measurement result to the other arithmetic processing circuit, and
at least one of the first arithmetic processing circuit and the second arithmetic processing circuit compares measurement results of the sensor, which are grasped by the respective arithmetic processing circuits, with each other to determine whether or not the second power supply circuit is abnormal.
